(19) United States
(12) Patent Application Publication
(10) Pub. No.: US 2019/0099862 A1
(43) Pub. Date: Apr. 4, 2019

(54) JEWELRY MOUNT DEVICE

(71) Applicant: Roman Simantov, Brooklyn, NY (US)

(72) Inventor: Roman Simantov, Brooklyn, NY (US)

(21) Appl. No.: 16/151,905

(22) Filed: Oct. 4, 2018

Related U.S. Application Data
(60) Provisional application No. 62/567,996, filed on Oct. 4, 2017.
(60) Provisional application No. 62/568,024, filed on Oct. 4, 2017.
(60) Provisional application No. 62/568,040, filed on Oct. 4, 2017.

(51) Int. Cl. B25B 5/02; B25B 5/10

(52) U.S. Cl. CPC B25B 5/02; B25B 5/10

(57) ABSTRACT

Embodiments of the invention are directed towards apparatus for securing workpieces in a workpiece retention device or clamp. In one embodiment, a workpiece retention tool is described, where the work piece retention tool comprises a clamp assembly and at least two gripping attachments configured to retain the workpiece. The gripping attachments are configured to exert a compressive force of the workpiece. In a particular implementation, the two gripping attachments include base and retention head portions. Here, the retention head portion is further defined with a top portion and a bottom portion defining an inclined gripping surface.

### CROSS REFERENCE TO RELATED APPLICATIONS

This application claims priority to U.S. Application No. 62/567,996, filed on Oct. 4, 2017. This application claims priority to U.S. Application No. 62/568,024, filed on Oct. 4, 2017. This application claims priority to U.S. Application No. 62/568,040, filed on Oct. 4, 2017. Each of the foregoing applications are herein incorporated by reference as if presented in their respective entireties.

### FIELD OF THE INVENTION

The present invention is directed to workpiece mounts broadly and more specifically to jewelry mounts used in connection with precious stone setting and engraving work.

### BACKGROUND OF THE INVENTION

Precious stone setting/and or ornamental engraving is a precise art form requiring skill and deftness. Usually, a skilled craftsman combines precious metals (e.g. gold and silver) with precious stones in artful configurations. Such combinations and work demand a high level of accuracy and precision. Craftsman often work with a microscope to magnify the workpiece so that they can achieve and perform their best work while ensuring that the expensive materials like gold plating, precious, semi-precious stones and diamonds are used efficiently without waste.

The craftsman's approach to the workpiece is usually includes the use of specialized or customized tools and materials. Such tools help the craftsman accomplish the task by securing the work piece or providing additional point of rotation or attachment for the craftsman to deploy.

There exist in the art tools to support and hold workpieces processed by a craftsman. For example, clamps, hand-tools, ball vises or engraving blocks are used by craftsman to secure a workpiece during engraving or other actions. Conventional ring clamps are used to secure a work piece. For example, clamps can hold the workpiece securing on a work surface freeing up the craftsman to utilize both hands to work on a project. However, standard clamps can be too big to use with small objects, such as small pendants and rings. Thus, what is needed in the art are tools specifically configured to assist a craftsman to work on small objects.

Additionally, craftsmen usually need to keep in mind the safety of the work piece (such as a ring) so as to not damage the workpiece in the process of setting stones or engraving the metal. Operations relating to the manufacture, repair, polishing, and cleaning of jewelry commonly require the use of small clamps or vises to firmly hold and position pieces of jewelry while they are being worked. Because of the nature of these operations, it is highly desirable that a clamp be capable of firmly positioning a piece of jewelry in any one of a number of different orientations. However, often when tightened, such clamps begin to bow or spread out, thereby lessening the grip on the workpiece being worked on. Thus, what is needed is a tool that also improves the grip that a vise or clamp exercises on an object.

Thus, what is also needed in the art are clamps or work-piece holding devices that permit the craftsman to secure a workpiece so as to engage in delicate work, while not damaging the workpiece.

### SUMMARY OF THE INVENTION

Embodiments of the invention are directed towards apparatus for securing workpieces in a workpiece retention device or clamp. In one embodiment, a workpiece retention tool comprises a clamp assembly and at least two gripping attachments configured to retain the workpiece. The gripping attachments are configured to exert a compressive force of the workpiece. In a particular implementation, the two gripping attachments include base and retention head portions. Here, the retention head portion is further defined with a top portion and a bottom portion defining an inclined gripping surface. In one or more illustrative configurations, the top portion of the retention head extends beyond the bottom portion of the retention head forming the inclined surface. In a further configuration, the degree of incline of the gripping surface is less than 10 degrees.

In a further implementation, embodiments of the invention are directed towards apparatus for a workpiece retention tool comprising an expansion collar having a cylindrical shape adapted to secure substantially cylindrical workpiece, the expansion collar having a plurality of slots extending from a first end face, and a plurality of slots extending from a second face, wherein the plurality of slots extend at least half the width of the expansion collar; at least two expansion promoters configured to engage the first face and second face and cause the first and second faces to increase in diameter in response to a compressive force. The apparatus further includes a mounting element configured to mount the workpiece retention tool on or to a surface and a selectively engagable compression device configured to apply compressive force to at least the two expansion promotors so as to apply compressive force to the first and second faces of the expansion collar.

In an alternative configuration, the workpiece retention tool includes a workpiece retention tool, comprising: a collar having a three-dimensional shape adapted to secure a workpiece, the collar having a plurality of groves disposed on a plurality of exterior faces, at least two receiving ports disposed in opposing faces, where the opposing faces are orthogonal to the plurality of exterior faces; at least two expansion promoters configured to engage the receiving ports of the opposing faces; a mounting element configured to mount the workpiece retention tool on or to a surface; and a selectively engagable compression device configured to apply compressive force to at least the two expansion promotors so as to apply compressive force to the opposing faces of the collar. Wherein the collar can be semi cylindrical or cubic in shape.

In yet a further configuration, in one or more particular implementations, the workpiece mount or retention device includes a tool configured to permit a user to mount the workpiece on a flexible hinge arrangement that allows the selection of different angles of approach. By way of non-limiting example, the present invention includes a base portion comprising an elongated shaft member, a hinge member disposed at one end of the elongated shaft member, the hinge member having at least one through bore disposed therein, and A workpiece mount comprising a connection portion configured to removably couple to the hinge member, an angled mounting shaft connected at one end to the connection portion, and a vertical mounting shaft connected to the other end of the angled mounting shaft, wherein the angled mounting shaft has at least one though bore disposed within the angled mounting shaft, and the vertical mounting shaft having at least one through bore disposed therethrough.

In yet a further configuration, A workpiece retention tool is provided that comprises a collar having a three-dimensional shape adapted to secure a workpiece, the collar having a plurality of groves disposed on a plurality of exterior faces, at least two receiving ports disposed in opposing faces, where the opposing faces are orthogonal to the plurality of exterior faces. The workpiece tool also includes at least two expansion promoters configured to engage the receiving ports of the opposing faces and a mounting element configured to mount the workpiece retention tool on or to a surface. In a further implementation, the workpiece tool also includes a selectively engagable compression device configured to apply compressive force to at least the two expansion promotors so as to apply compressive force to the opposing faces of the collar.

### BRIEF DESCRIPTION OF THE DRAWINGS

The workpiece mount and tools are illustrated in the figures of the accompanying drawings which are meant to be exemplary and not limiting, in which like references are intended to refer to like or corresponding parts, and in which:

FIG. 1 shows a side view of the workpiece mount according to a particular embodiment of the present invention.

FIG. 2 shows a side view of one gripping arm of the workpiece mount according to a particular embodiment of the present invention.

FIG. 3A-D shows views of particular elements of the workpiece mount according to one or more configurations of the present invention.

FIG. 4A-B shows views of particular elements of the workpiece mount according to one or more configurations of the present invention.

FIG. 5 shows an exploded perspective view of the workpiece mount according to a particular embodiment of the present invention.

FIG. 6 shows a perspective side view of the workpiece mount one according to a particular embodiment of the present invention.

FIG. 7 shows a top view of particular elements of the workpiece mount according to one or more configurations of the present invention.

FIG. 8 shows a side elevation view of particular elements of the workpiece mount according to one or more configurations of the present invention.

FIG. 9 shows a plurality of views of particular elements of the workpiece mount according to one or more configurations of the present invention.

FIG. 10 shows a plurality of views of particular elements of the workpiece mount according to one or more configurations of the present invention.

FIG. 11 shows a plurality of views of particular elements of the workpiece mount according to one or more configurations of the present invention.

FIG. 12 shows a plurality of views of particular elements of the workpiece mount according to one or more configurations of the present invention.

FIG. 13 shows a perspective view of the workpiece mount according to a particular embodiment of the present invention.

FIG. 14 shows an exploded perspective side view of the workpiece mount one according to a particular embodiment of the present invention.

FIG. 15 shows a side elevation view of particular elements of the workpiece mount according to one or more configurations of the present invention.

FIG. 16 shows a side view of particular elements of the workpiece mount according to one or more configurations of the present invention.

FIG. 17 shows a top view of particular elements of the workpiece mount according to one or more configurations of the present invention.

FIG. 18 shows a side of view of particular elements of the workpiece mount according to one or more configurations of the present invention.

FIG. 19 shows a side of view of particular elements of the workpiece mount according to one or more configurations of the present invention.

FIG. 20 shows a side of view of particular elements of the workpiece mount according to one or more configurations of the present invention.

FIG. 21 shows a side of view of particular elements of the workpiece mount according to one or more configurations of the present invention.

FIG. 22 shows a bottom of view of particular elements of the workpiece mount according to one or more configurations of the present invention.

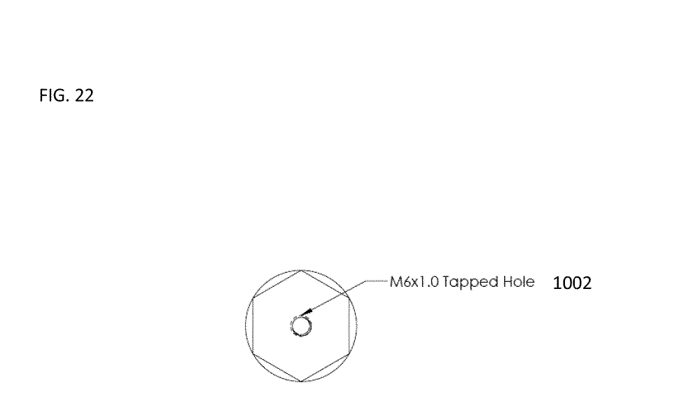

FIG. 23 shows a side view of particular elements of the workpiece mount according to one or more configurations of the present invention.

### DETAILED DESCRIPTION OF CERTAIN EMBODIMENTS OF THE INVENTION

By way of overview, various embodiments of the apparatus described herein are directed to workpiece mounts configured to hold or retain a workpiece. Such described devices permit the securing of a delicate and easily damaged workpiece, such as jewelry or small decorative items, so that a craftsman can create, or repair such items.

Due to the complexity of the work, it is essential that the craftsman be comfortable with supporting tools. The work piece, such as a ring, is firmly and securely locked in place between the arms of a clamp without damaging it. For example, the craftsman might use a small vice with soft or flexible removable jaws to secure a workpiece. With a workpiece secured, the craftsman can work with a steady speed in different places on the workpiece while adjusting and positioning the workpiece so that the craftsman is comfortable and can approach the work piece from different angles, so as to make different drill cuts and setting stone or engravings.

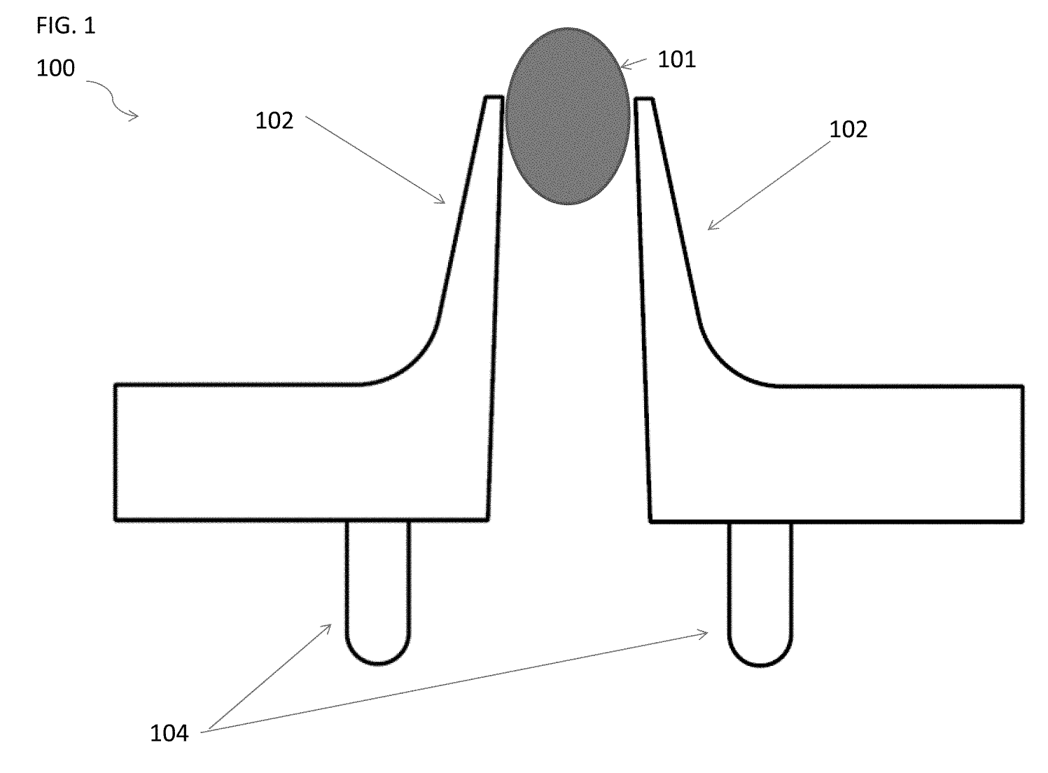

With respect to FIG. 1, the work piece mount 100 includes a pair of gripping arms 102. The gripping arms 102 secure a workpiece 101 and permit the craftsman to utilize both hands to work on the workpiece 101 without danger of the work piece slipping. In a particular implementation, the workpiece 101 is a ring, ornament, pendant, bracelet, charm, earing, timepiece, decorative element or other object that a user desires to secure. In a further implementation, the workpiece 101 is formed of a material, metal, composite or combination thereof, such as gold, silver, steel, wood, brass, or a composite material, or a composite of composite materials.

The gripping arms 102 are configured for integration into a mount, adjustable clamps or other retaining structure (not shown). In a particular configuration, the gripping arms 102 are made of any material, metal, composite or combination thereof suitable for the proposes and tasks described herein. In one arrangement, the retaining structure is a ball vise or other configurable clamp, such as The GRS engraving block ball vise manufactured by Esslinger of Saint Paul, Minn. In a particular arrangement, the ball vise or clamp is customized for jewelry repair, stone setting, hand engraving, model making, or other precision craftsmanship. In a further configuration, the retaining structure includes self-centering jaws that incorporate tooling holes that can accept a multitude of attachments or pins. In yet a further configuration, the clamp or vise is configured to rotate in any direction on a base/socket.

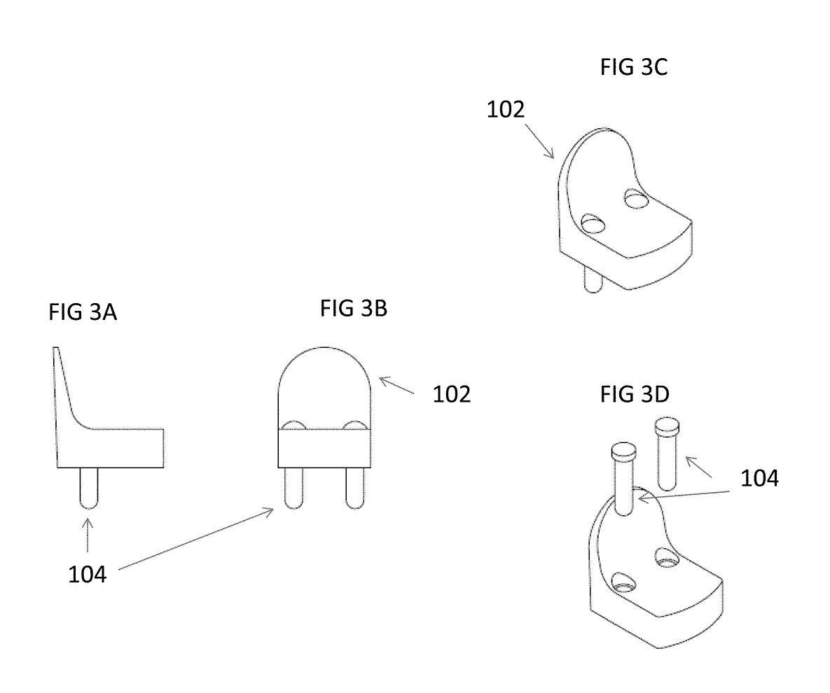

As shown in FIGS. 3A-3D, the mounting elements 104 are used to integrate each gripping arm 102 into the retaining structure. Here, the mounting elements 104 are, in one configuration, coextensive with the gripping arms. However, in an alternative configuration as shown in FIG. 3D, the mounting elements 104 are selectively removable from the gripping arms 102. Where the mounting elements 104 are removable, the mounting elements 104 are formed out of the same or a different material than the gripping arms. In a further arrangement, the mounting elements 104 include one or more surface features that enhance contact with the retaining structure. For example, the mounting elements 104 include magnets so as to releasably secure the mounting elements 104 to the retaining structure. In an alternative arrangement, the mounting elements 104 are configured with surface textures, arrestors, barbs or other features design to enhance the coefficient of friction between the mounting element 104 and retaining structure.

In yet a further arrangement, the mounting elements 104 include one or more clips, sockets, receivers or other arrangement or configuration that releasably secure the gripping arms to a ball vise or retaining object. For example, the mounting elements 104 include a rail and channel, or tab and slot configuration that allows the gripping arm to be secured to jaws of the ball vase.

In an alternative configuration, the gripping arms 102 are integral to the jaws of the ball vase.

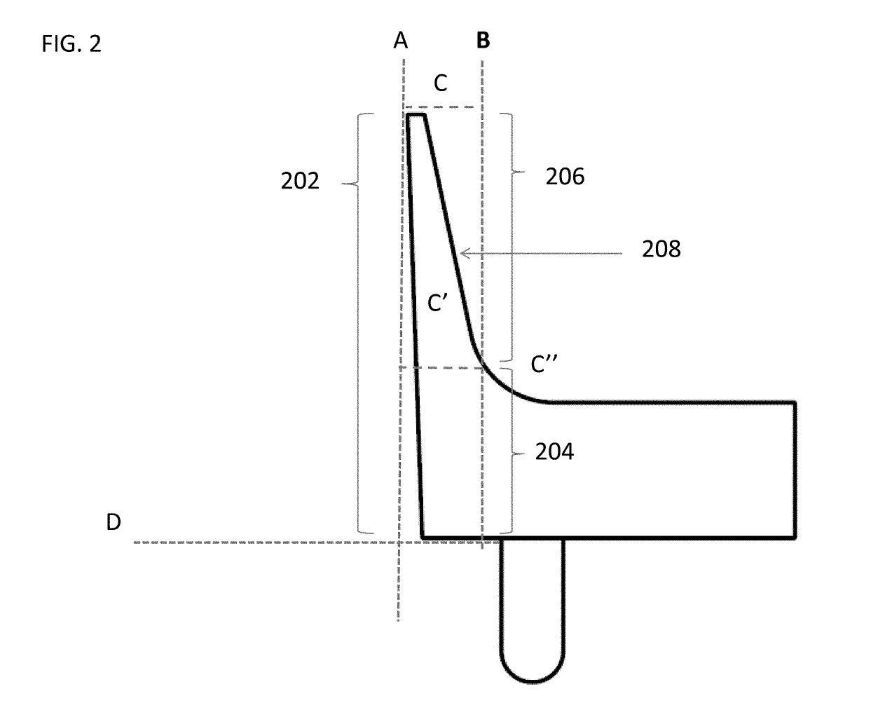

As further shown in FIG. 2, the gripping arms 102 have gripping surface 202. In one configuration, the gripping surface 202 extends from a base portion 204 to a top portion 206 along surface line A. As shown with particular detail, vertical line A extends from the top of the top portion 206 to the bottom of the bottom portion 204. The gripping surface 202 is angled as it extends from the top portion 206 to the bottom portion 204, thus forming an incline. As a result of this incline, the top portion 206 of the gripping arm 102 forms an overhang relative to the base portion 204. As shown, vertical line A begins in contact with the top potion 206 of the gripping arm (defined by horizontal line C). At the bottom portion of the gripping surface defined by horizontal line D, the gripping surface 202 is no longer in contact with vertical line A. The distance between the vertical line A, denoting the relative position of the top portion of the gripping harm 102, and the bottom portion of the gripping arm is related to the degree of incline.

In one configuration, the amount of overhang is correlated to the degree of incline of the gripping surface 202 configured such that a top portion 206 of the gripping arm 102 is off-set from the bottom portion 204 of the gripping arm 102. In one particular implementation the degree difference between the horizontal plane A and the bottom of the gripping wall is between 1 and 10 degrees. In a further implementation, the difference between the horizontal plane A and the bottom of the gripping wall is two (2) degrees.

For example, where the angle formed between the gripping surface C′ and vertical line A is equal to two (2) degrees, the amount of overhang of the top portion relative to the bottom portion can be calculated according to the length of the gripping surface 202, the Law of Sines/Cosines and the fact that each angle of the hypothetical triangle defined by horizontal line D, and vertical lines C′ and A will add to 180 degrees.

In a further configuration shown in FIG. 2, the width of gripping arm 102 decreases along the length of the gripping surface 202, such that the width at height C is less than the width of the gripping wall at height C″. As a result, a back portion 208 of the gripping walls 102 angled relative to a vertical line B. In one arrangement, the back portion 208 is angled at 45 degrees from the vertical line B.

Without being limited to any mechanism of action, the angle of the gripping surface 202 and the back portion 202 of the gripping arm 102 are configured such that upon tightening the gripping arms 102 on the workpiece, such as through a ball or vise clamp integral with the gripping arms, the gripping surface exerts a progressively increasing retention force on the workpiece. Thus, when the gripping arms are tightened, the tendency for the top portion of the gripping arms 102 to bend outward or otherwise loose gripping force on the work piece is substantially eliminated.

As shown with reference back to FIG. 1, the craftsman locks the ring in place and can adjust the positing of the workpiece. Most metals worked with by the craftsman are softer precious metals that can be damaged. Therefore, the clamps, when tightened form an angle on the gripping walls will precipitate the application of compressive force without allowing the ring any free space to move. Such a configuration of elements permits the workpiece to be secured between the clamps and prevents the gripping walls 202 from bowing outward as is common when applying compressive force to a workpiece with clamp attachments.

In a yet further configuration, the gripping surface 202 includes one or more retention or protection devices (not shown). For example, the gripping surface can include a fabric or rubber layer that prevents abrasion or scaring of the work piece. Alternatively, where the workpiece is a highly durable, yet smooth material such as precious stones, the gripping surface 202 includes one or more texturing agents designed to increase the coefficient of friction between the gripping surface and the workpiece. In one arrangement the texturing agent is a rubber or other material applied to the gripping surface. Alternatively, the gripping surface 202 includes engraved, cast or etched texture, such as ridges, bumps, divots, channels or other structures configured to enhance the gripping properties of the gripping surface 202.

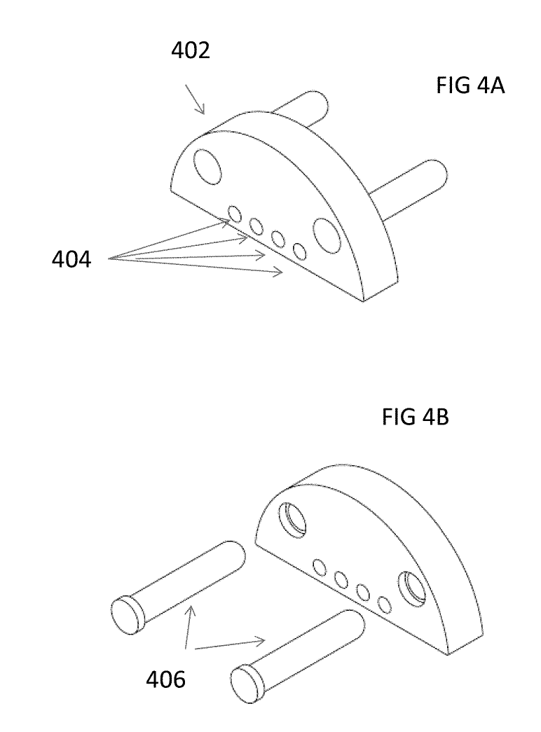

As shown with respect to FIGS. 4A-4B, the gripping arms 102 are configured for insertion into an adaptor mount 402. In one particular implementation, the adaptor mount 402 includes receiver or receptacles 404 configured to accept the mounting elements 104. In one arrangement, the mounting elements 104 are inserted into the receiving receptacles 404 provided in the surface of the adaptor mount 402. For example, a plurality of receiving holes distributed across one or more planar surfaces of the adaptor mount that are sized to accept the mounting elements 104. While the particular implementation shown provides for four (4) inserts, regularly spaced in the center of the end portion of the adaptor mount, those possessing an ordinary level of skill in the requisite art will appreciate that the receiving receptacles 404 may be placed at any position on the adaptor mount 402, including on a side surface or inner surface of the adaptor mount, if suitable receptacles are found.

In yet a further implementation, the receiving receptacles 404 are configured with one or more mechanical, or magnetic, properties that allow for the gripping arms 102 to be selectively coupled to the adaptor so as to permit inversion or tilting of the ball vase without the insert being dislodged or removed by chance or mistake.

As shown in FIG. 4B, the adaptor mount is configured with one or more adaptor mounting elements 406. These adaptor mounting elements 406 are configured to interface with one or more receiving elements on the jaws of the ball mount. In one particular arrangement, the adaptor mounting elements 406 are removable or configurable depending on the make and model of the ball vise or clamp used. For example, the adaptor mounting elements 406 can be replaced or substituted depending on the user's needs or conditions encountered.

In a alternative configuration of elements wherein the reference numerals are used to refer to alternative elements, replaced

Due to the complexity of the work, it is essential that the craftsman be comfortable with supporting tools. The work piece, such as a ring, is slid over an expansion collar such that at least a portion of the interior surface of the ring is in contact with an exterior surface of the expansion collar.

With the ring in place over the expansion collar, a pair of expansion promoters are used to cause the openings of the variable diameter mount to expand and come into contact with the workpiece without damaging it. For example, the craftsman might use a wingnut bolt or other compression device to force a portion of the expansion promoters into the expansion collar to secure a workpiece. With a workpiece secured, the craftsman can work with a steady speed in different places on the workpiece while adjusting and positioning the workpiece so that the craftsman is comfortable and can approach the work piece from different angles, so as to make different drill cuts and setting stone or engravings.

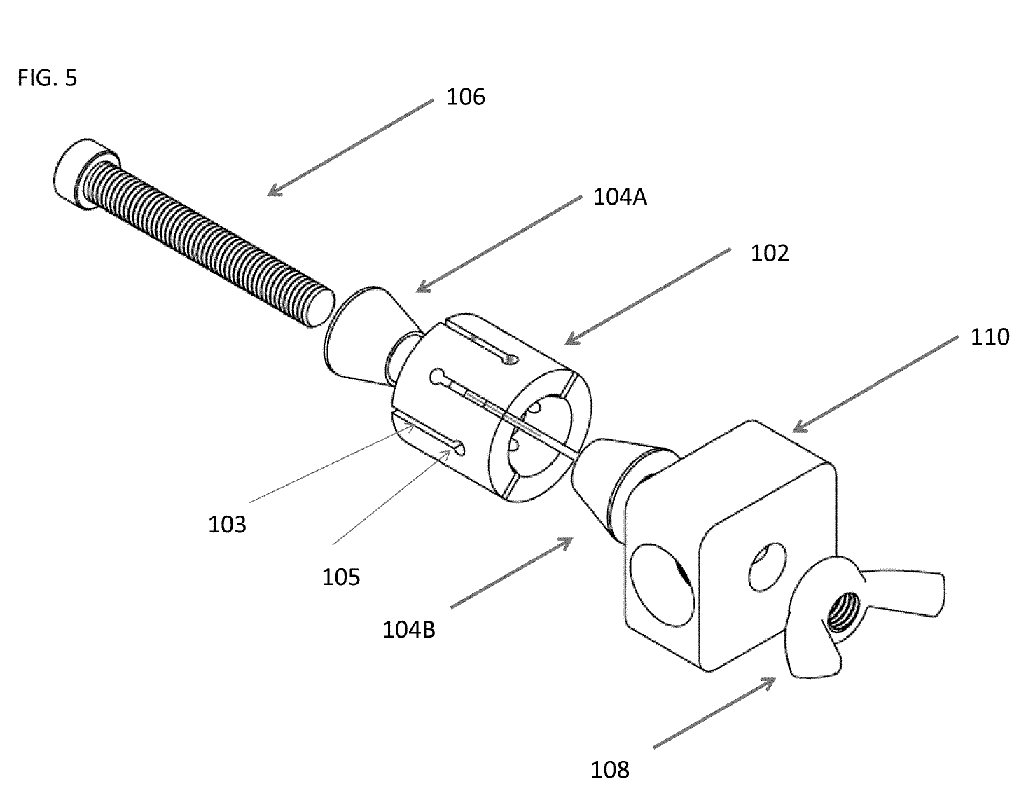

With respect to FIG. 5, the work piece retention apparatus 100 includes an expansion collar 102 having a cylindrical shape adapted to secure substantially cylindrical workpiece. For example, the expansion collar has a first face and second face disposed on opposing sides of the length of the cylindrical body of the expansion collar. In a particular implementation, the expansion collar 102 is formed of a solid piece of material. In an alternative implementation, the expansion collar is rectangular in shape. In a further implementation, the expansion collar 102 is polygonal in shape or cross-section.

Upon the application of compression force on either or both faces of the expansion collar 102, the material of the expansion collar 102 causes the expansion collar 102 to expand in one or direction orthogonal or semi-orthogonal to the direction of compression.

In an alternative configuration, the expansion collar 102 is hollow or semi-hollow. Here, the walls defining the cylindrical portion of the expansion collar 102 have a given thickness. For example, the thickness of the walls of the cylinder are between 1% and 99% of the radius of the cylinder defined by the expansion collar 102.

The expansion collar 102 is formed or one or more materials suitable for the features and conditions described herein. For example, the expansion collar 102 is formed of one or more plastic, rubber, composite, natural, synthetic, metal, wood, or other material suitable for deforming or expanding under compressive forces.

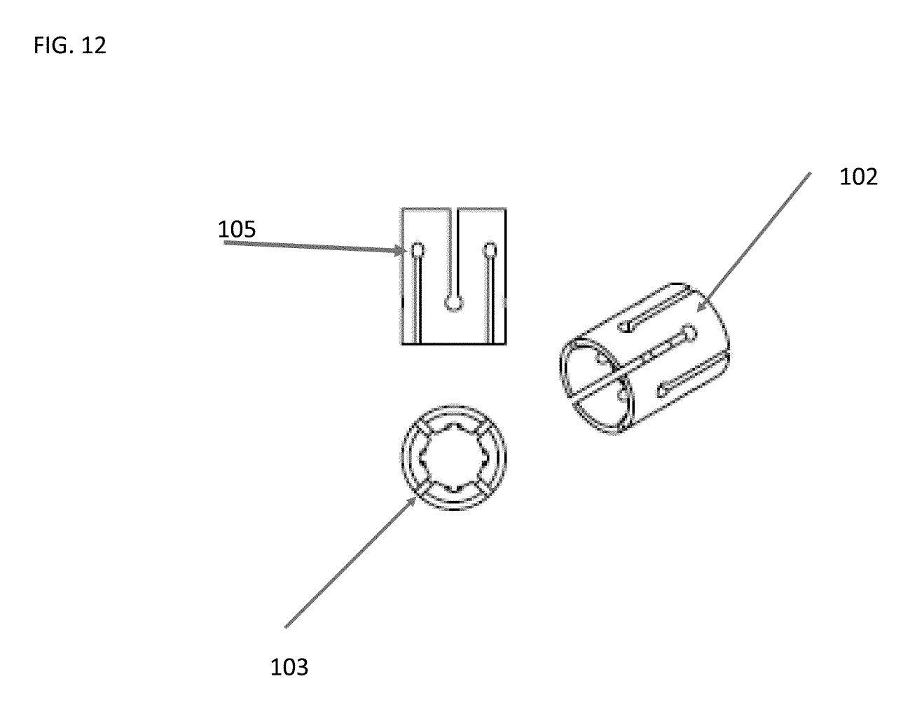

In one or more implementations, the expansion collar 102 has a plurality of channels 103 extending from a first end face and/or from the second face of the expansion collar 102. As shown in more detail in FIG. 12, the channels 103 are configured to extend though the side walls of the expansion collar 102 to the interior void of the expansion collar 102. In an alternative configuration, the channels 103 extend partially though the thickness of the side walls so that no passage is provided. In one or more implementations, the channels 103 are formed such that when the expansion collar 102 is not under compressive pressure, one or more sides, that is lateral faces disposed within at least a portion of the sidewall of the channel 103, are is separable contact with one another. In an alternative configuration, the lateral faces of the channel are separated from one another by a distance. In one or more configurations, the distance between the lateral faces of the channels 103 is set so that upon expansion of the expansion collar, the lateral faces of the channels (i.e. the side walls of the channel 103) will not encounter one another during anticipated expansion.

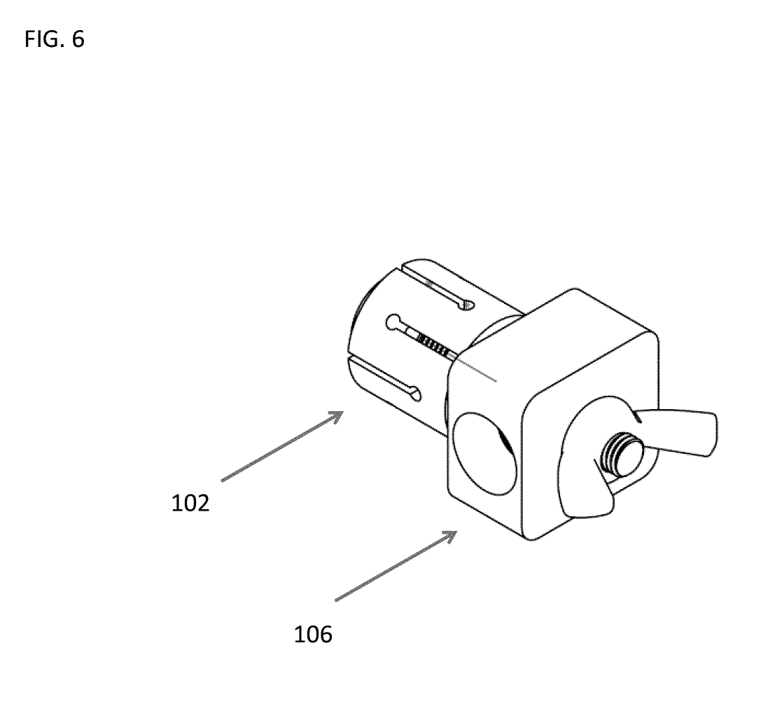

As shown in FIGS. 5, 6 and 8, the channels 103 of the expansion collar 102 terminate in passage 105. In one arrangement, the passage 105 is a circular opening in the sidewalls of the expansion collar 102. In a further implementation, the passages 105 are polygonal openings within the sidewalls of the expansion collar 102.

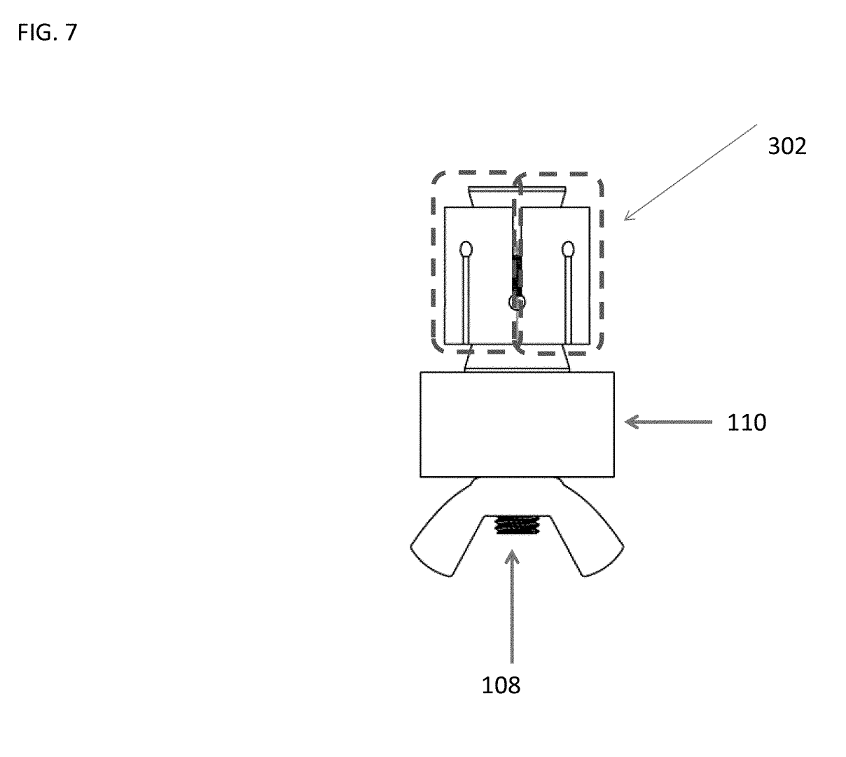

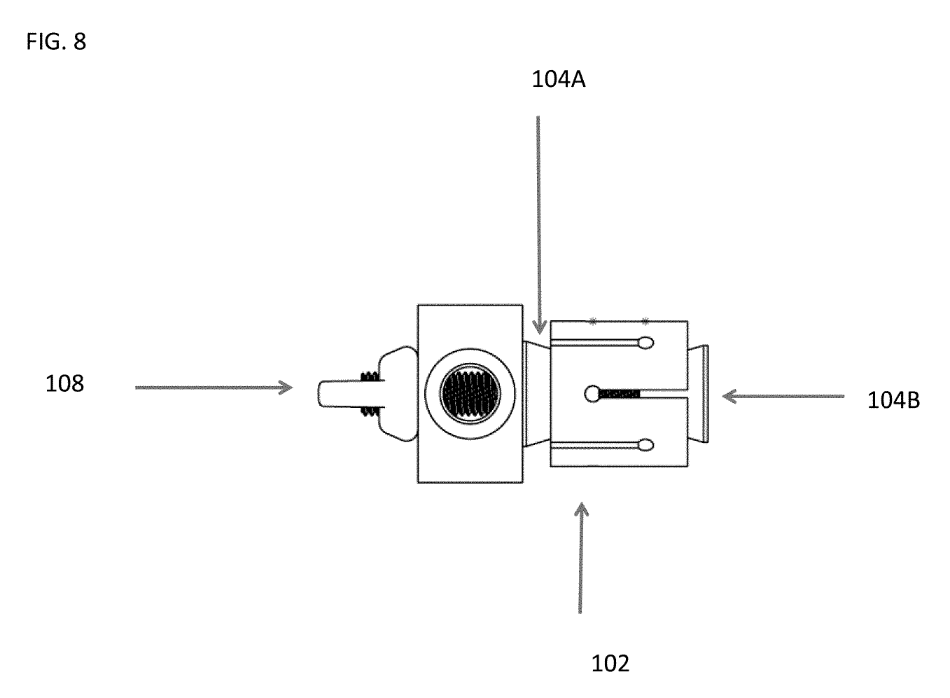

The expansions collar 102 is configured to accept at least one expansion promotor 104A/B. As shown in FIG. 7, the expansion promotors 104A/B are configured to be introduced into the open faces of the expansion collar 102. As shown with particular reference to FIG. 8, the expansion promotors 104A/B are conical or fusoconical in shape. Alternatively, the expansion promotors are pyramidal in shape. In a further implementation, the expansion promotors 104A/B are polyhedral in shape.

In yet a further implementation, the expansion promotors are formed the same material as the expansion collar 102. However, in alternative implementations, the expansion promotors 104A/B are formed of materials harder, denser or less compressible than the material of the expansion collar 102. The expansion promotors are further equipped with a retaining mount or passage that permits an expansion bolt 106 to be passed through the expansion promotors 104A/B. In one arrangement, the retaining mount or inner passage is threaded to accept threaded screws or fasteners.

Alternatively, the expansion promotors 104A/B are mounted on any means for progressively introducing the expansion promotors into the open faces of the expansion collar 102. For example, the expansion promotors 104A/B are part of a vise or clamp structure that permits the progressive positioning of the expansion promotors 104A/B closer together or farther apart.

Returning to FIG. 5, expansion bolt 106 is configured to pass through the expansion collar 102 and the expansion promotors 104A/B. For example, the expansion bolt 106 is configured to be threaded through the expansion promotors 104A/B and the expansion collar 1-2. Alternatively, neither the expansion collar 102, nor expansion promotors 104A/B are configured with inner threading. At least a portion of the expansion bolt 106 is passed through a mounting block 110. Additionally, at least one end of the expansion bolt 106 is configured to be secured with a securing device 108.

In a specific embodiment, the mounting block is a structure for mounting the workpiece retention. For example, the mounting block 110 is configured so as to be mounted or secured upon a ball vise or other configurable clamp, such as The GRS engraving block ball vise manufactured by Esslinger of Saint Paul, Minn.

Without being held to any particular method or form or operation, when the securing device 108 is tightened against the mounting block, the expansion promotors are advanced into the open faces of the expansion collar 102. As shown in FIG. 7, the advancing expansion promotors 104A/B cause the expansion sections 302 of the expansion collar 102 to extend outward, effectively increasing the diameter of the expansion collar 102. As such, rings or other circular jewelry of many different inner diameters can be accommodated by a single expansion collar based tool.

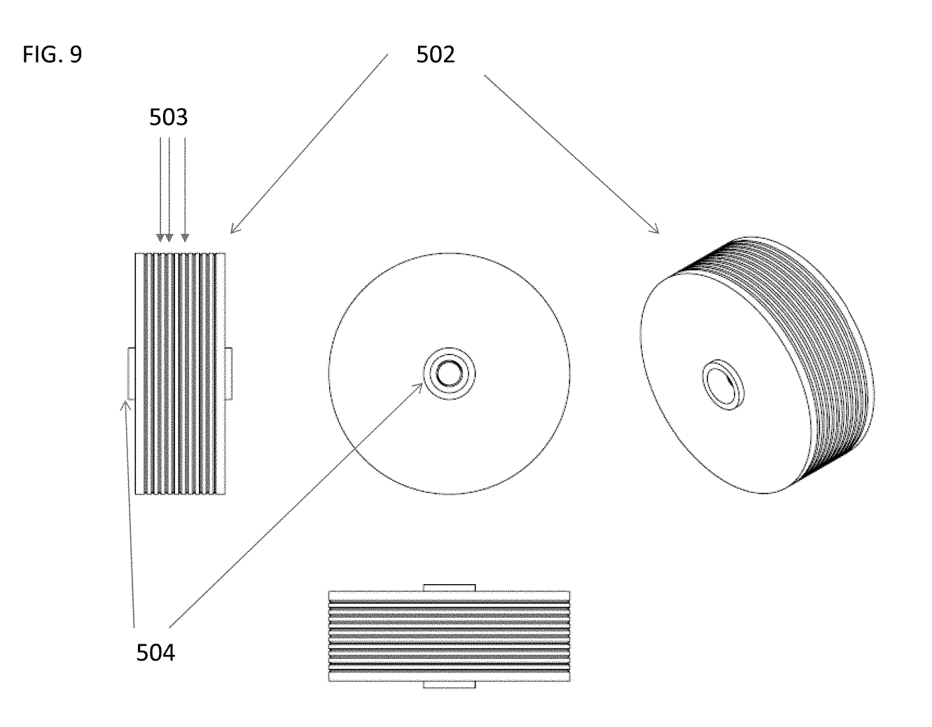

Turning to an alternative embodiment, as illustrated in FIG. 9, the work piece retention tool uses a securing collar 502 as opposed to the expansion collar previously described. Here the securing collar 502 is a cylindrical or semi-cylindrical work piece mount. Depending on the size, diameter or shape of the workpiece, the securing collar 502 includes one or more striations or groves 503. The groves 503 permit the application of shellac, rubber, or another compound that increases the diameter of the securing collar 502. Additionally, the application of shellac or another compound provides a change in surface texture. For example, shellac applied to the securing collar 502 allows a workpiece to be mounted and retained to the securing collar 503 without the use of clamps, clips or mounting hardware that can damage or mar the work piece.

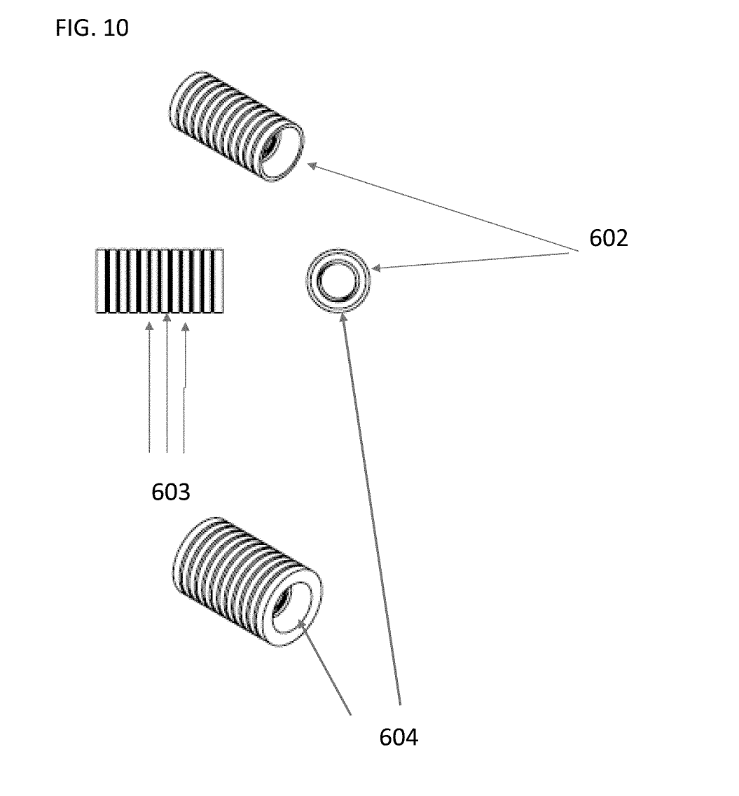

The securing collar 502 further includes mounting ports 504. The mounting ports 504, in one implementations are adapted to interface with the expansion promoters 104A/B. Thus, upon securing the securing collar 502 within between the expansion promotors 104A/B the expansion promotors intrude into the mounting ports 504. As a result, the securing collar 502 is secured. For instance, by using expansion promotors 104A/B, the securing collar 502 is prevented from wobbling or otherwise shifting during work on the workpiece.

Where smaller workpieces are being worked on, the cylindrical collar 602 can be used instead of either the expansion collar 102 or the securing collar 502. Like the securing collar 502, the cylindrical collar 602, as shown in detail in FIG. 10, is a cylindrical or semi-cylindrical work piece mount. Depending on the size, diameter or shape of the workpiece, the cylindrical collar 602 includes one or more striations or groves 603. The groves 603 permit the application of shellac, rubber, or another compound that increases the diameter of the cylindrical collar 602. As previously stated, the application of shellac or another compound provides a change in surface texture and allows the work piece to be secured without the use of clamps, clips or mounting hardware that can damage or mar the work piece. The cylindrical collar 602 further includes mounting ports 604. In a particular implementation, the mounting ports 604 are adapted to interface with the expansion promoters 104A/B. For example, upon tightening of the expansion bolt 106, the expansion promotors 104A/B intrude into the mounting ports 604. As a result, the cylindrical collar 602 is securely mounted to the work piece retention apparatus.

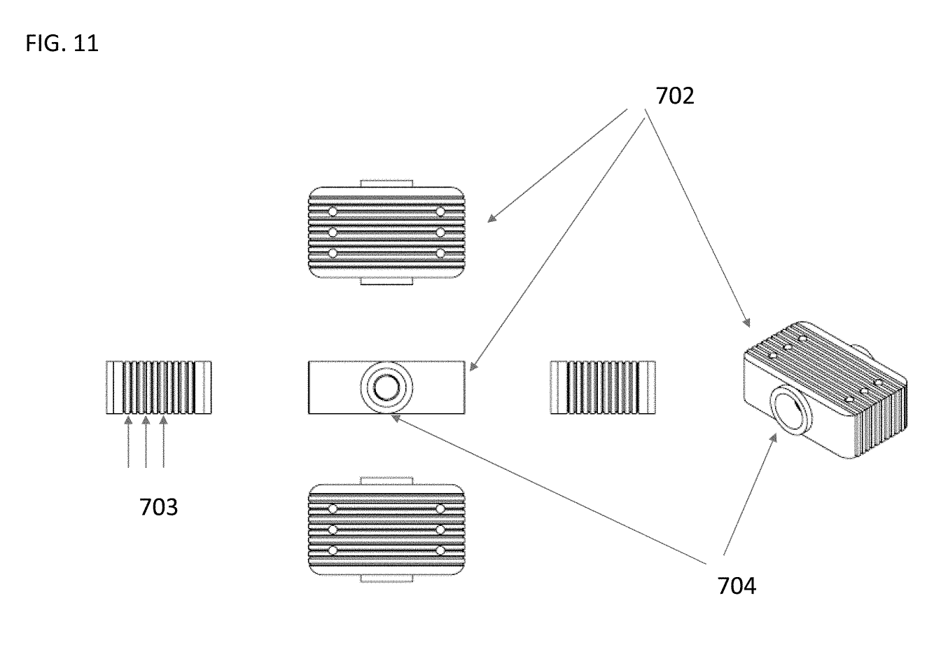

With reference to FIG. 11, where a collar block 702 is used to mount the workpiece instead of the other mounting approaches described previously. Like the securing collar 502, the collar block 702 is cubic, roughly cubic, or semi-cubic work piece mount. As illustrated in FIG. 11, the collar block 702 is designed such that a long work piece, such as a bracelet or necklace can be wrapped around one end, portion, or point of the collar block 702. In a further implementation, the collar block 702 includes one or more striations or groves 703. In a particular implementation, the groves 703 provide channels or paths to sit the work piece. Returning to the example of a necklace as the workpiece, here the groves 703 permit the necklace to rest in a number of channels so that a particular length of the necklace can be worked upon. In a further implementation, the groves permit the application of shellac, rubber, or another compound that increases the surface area or cross-sectional size of the collar block 702.

As with the other implementations, the collar block 702 further includes mounting ports 704. In a particular implementation, the mounting ports 704 are adapted to interface with the expansion promoters 104A/B. For example, upon tightening of the expansion bolt 106, the expansion promotors 104A/B intrude into the mounting ports 704. As a result, the collar block 702 is securely mounted to the work piece retention apparatus.

In yet a further implementation where the reference numerals are used to identify new elements, Due to the complexity of the work, it is essential that the craftsman be comfortable with supporting tools. Specifically, when a user desires to make repairs or alterations to a workpiece, the user needs comfort that the work piece will not move or shift. Furthermore, the user or craftsman needs flexibility in how the workpiece is oriented, so that the user may effectuate the changes in a manner most comfortable and least likely to result in damage to the work piece.

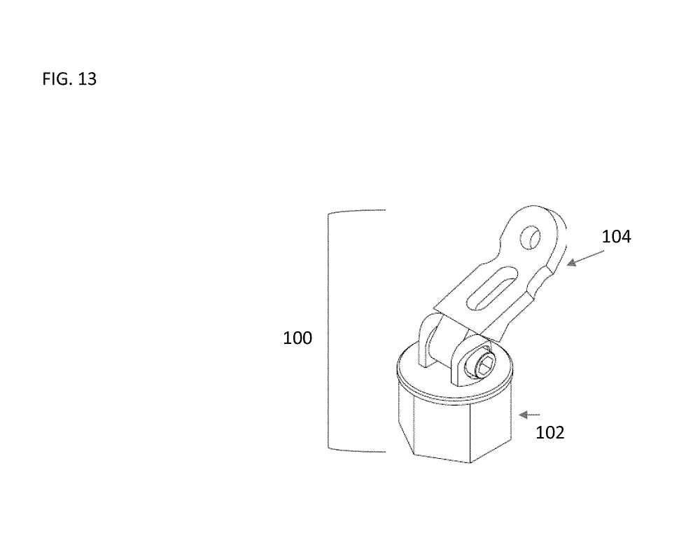

As shown with respect to FIG. 13 the work piece mount 100 permits the securing of a workpiece (e.g. a ring or other work piece) such that the work piece can be approached from different angles or directions. Those possessing an ordinary level of requisite skill in the relevant art will appreciate that the elements described herein can be formed of any suitable material, including but not limited to steel, iron, other metals or alloys, plastics, synthetics, or natural products (e.g. wood).

As shown, the workpiece mount 100 has a base portion 102 and a hinge mount 104. In one or more configurations, the base portion 102 has a cylindrical, or approximately cylindrical, shape. In another configuration, the base portion 102 has a cubic shape. In yet a further implementation, the base portion 102 has a hexagonal, octagonal or other similar shape.

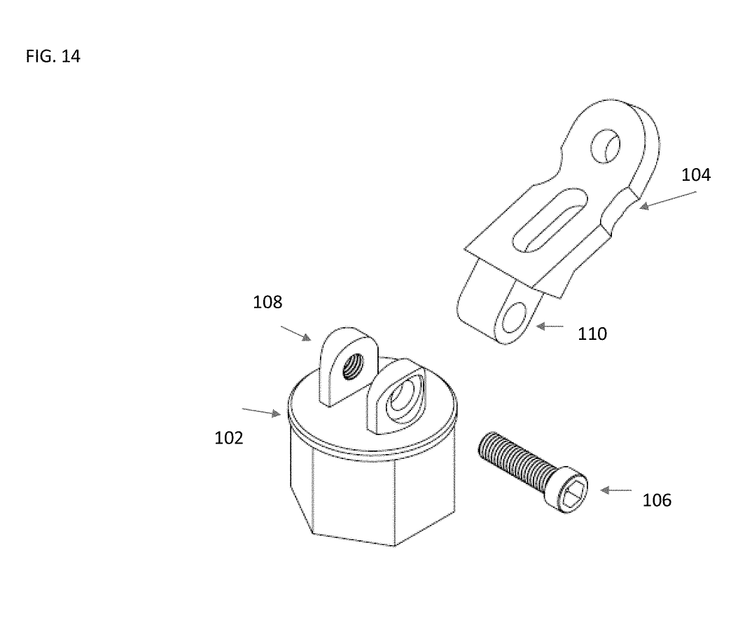

As shown in FIGS. 13 and 14, the base portion 102 has a hexagonal shape. Without limiting the potential arrangements of the base, the depicted base portion 102 is configured to fit within the jaws or clamps of a vise. For example, the base portion 102 is configured to fit in a ball vise or other configurable clamp, such as the GRS engraving block ball vise manufactured by Esslinger of Saint Paul, Minn.

Where the base portion 102 is formed of many flat surfaces, such six surfaces in the case of the hexagonal base, the base portion 102 can be easily rotated while ensuring a tight grip by the ball vase. In an alternative implementation, the base portion 102 is equipped with an attachment point 1002. For example, in FIG. 10 the attachment point 102 is used to secure a handle or other device that allows the user to have a grip on the workpiece mount. For instance, using the handle (not shown), the user can manipulate the workpiece mount 100 by rotating, inverting, or otherwise moving the workpiece mount into a suitable position. In yet a further implementation, the user can directly grasp the base portion 102 and manipulate the work piece mount 100 directly.

In a further implementation, the base portion includes an arrestor 406 that prevents the base portion 102 from sliding when secured by a clap. For instance, when the base portion 102 is secured in a vise clamp, the arrestor 406 prevents the base 102 from advancing beyond a certain point in the clamp when under pressure or force.

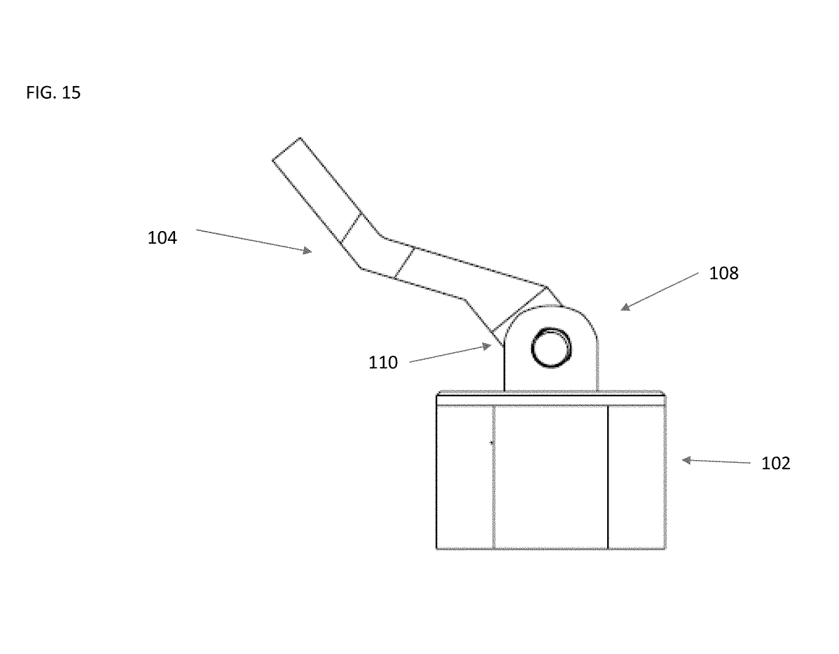

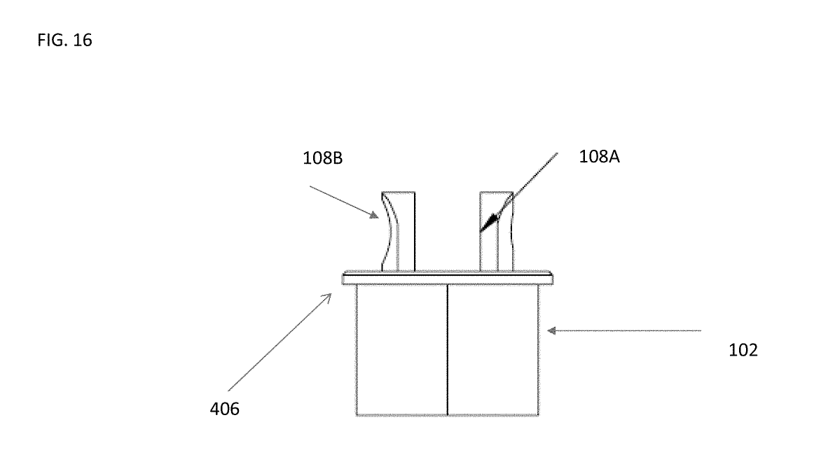

Returning to FIG. 14, the base portion 102 of the work piece mount 100 is equipped with a hinge receiver 108. In the illustrated implementation, the hinge receiver 108 is configured to receive a hinge portion 110 of hinge mount 104 and a securing bolt 106. In one implementation shown in FIG. 16, the hinge receiver 108 includes two risers 108A and 108B. In one or more implementations, the risers 108A/108B have through holes for the threading or passing of a securing bolt. In one arrangement, the raisers 108A/108B are is configured to secure a bolt 106. In an alternative configuration, the risers 108A/108B include locking or securing mean for securing a bolt. As further shown in FIGS. 14-15, the risers 108A/B includes a depression configured to receive a securing nut.

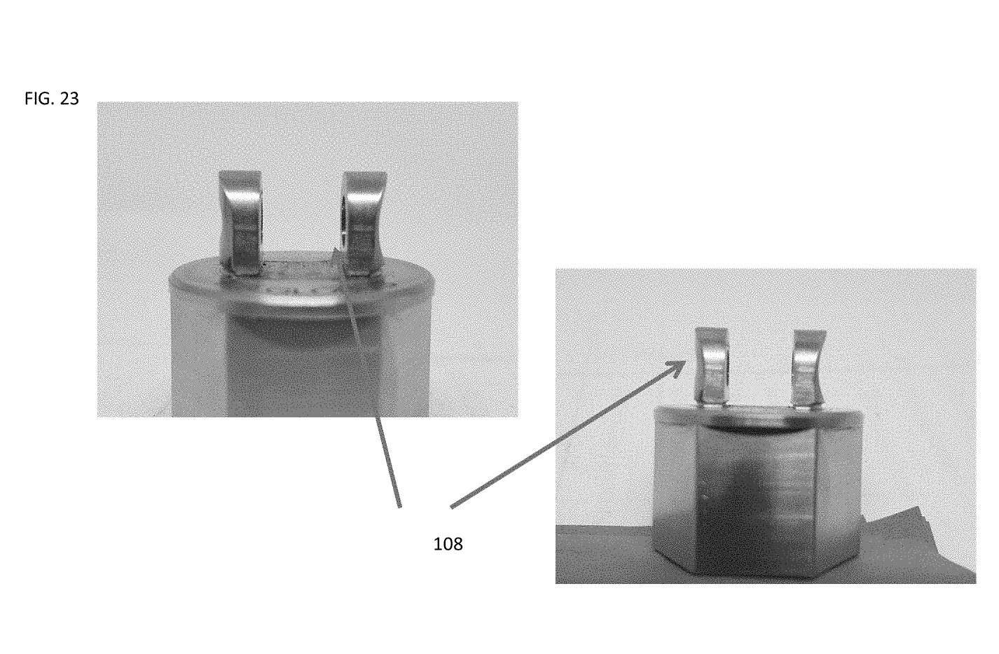

In one or more configurations, the risers 108A/108B includes one or more bevels, cuts, or grooves that impart a greater flexibility to the risers without sacrificing strength. For example, when the bolts or securing nuts are used to secure the hinge portion 110 of the hinge mount 104, the bevels introduced in the risers 108A/B impart a flexibility to the risers permitting increased compressive force to be applied to the hinge portion 110 when being secured. As shown with particular reference to FIG. 23, where the risers 108 have bevels introduced into an outer surface, the top portion of the riser is flexible relative to the base portion of the riser 108, In this manner, the risers 108 function to bend inward when compressive force is applied, such as when a securing bolt is introduced.

As shown in FIGS. 14-15, the hinge mount 104 includes a hinge portion 110. The hinge portion 110 connects the hinge mount 104 to the hinge receiver 108. For example, the hinge portion 110 is provided with a through bore. A securing bolt 106 or pin can be inserted into the hinge portion and the risers 108A/B to form a hinge that allows for the pivoting of the hinge mount 104 about the base portion 102.

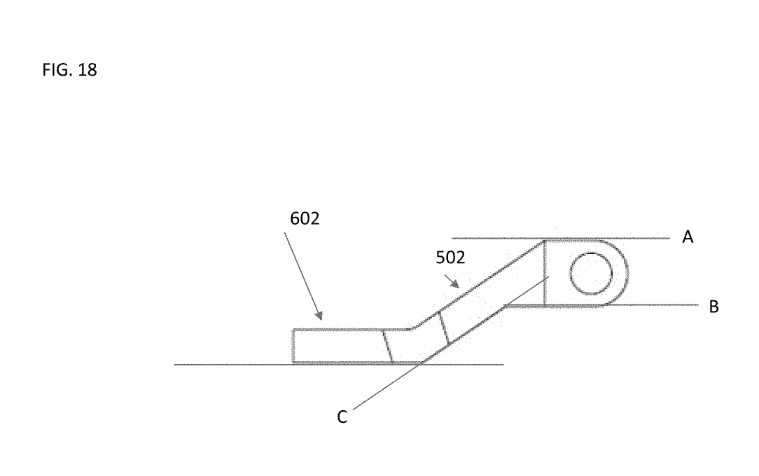

As shown in the foregoing figures, the hinge mount 104 includes an angled mounting shaft 504 that extends from the hinge portion 110. In one particular implementation illustrated in FIG. 18, the angled mounting shaft 504 is angled away from a plane A defined by the top portion of the hinge portion 110 and a plane B defined by the bottom portion of the hinge portion 110. For instance, the angled mounting shaft 504 extends away from the hinge portion 110 at an angle between 1 and 90 degrees. In a further implementation, the angled mounting shaft 504 extends away from the hinge portion 110 at an angle between 1 and 45 degrees. In a further implementation, the angled mounting shaft 504 extends away from the hinge receiver at an angle of 34 degrees.

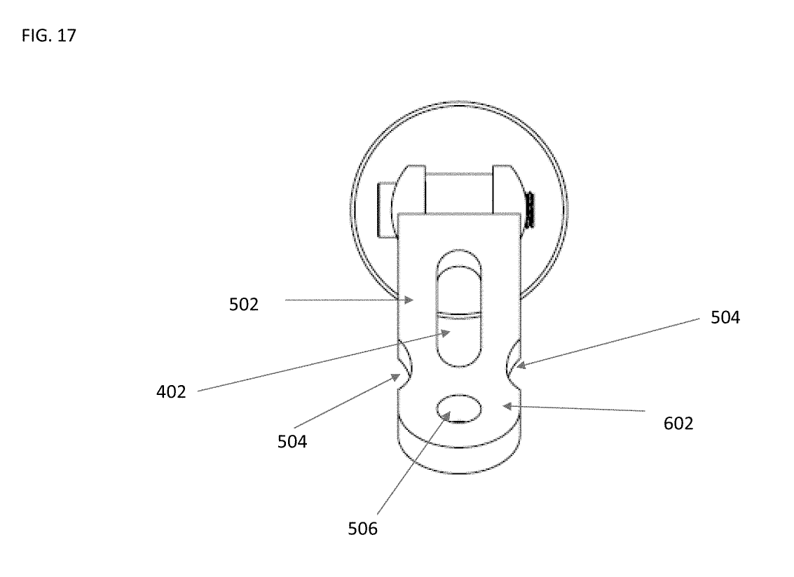

In one particular implementation, as shown in FIG. 17, the angled mounting shaft 504 includes a bore hole 402. In a further implementation, the bore hole 402 of the angled mounting shaft 504 is a slot or channel disposed though the body of the angled mounting shaft 502.

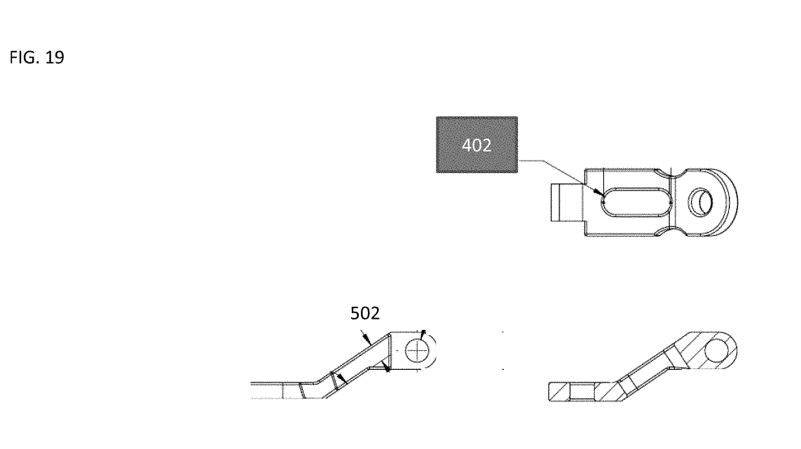

With particular reference to FIG. 19, In one or more configurations, the angled mounting shaft is approximately 20 centimeters in length and five (5) centimeters in width. However, those possessing an ordinary level of skill in the requisite art will appreciate that other suitable dimensions for the angled shaft are envisioned and contemplated.

As shown in a particular implementation of FIGS. 18-19, a straight mounting shaft portion 602 extends from one end of the angled mounting shaft 502. For example, the straight mounting shaft portion 602 extends 18 centimeters beyond the end of the angled mounting shaft. As noted previously, the straight mounting shaft 502 is angled away from the plane C defined by the bottom of the angled mounting shaft 502. For instance, the straight mounting shaft 502 is angled away from the plane C by between 1 and 90 degrees. In a further implementation, the straight mounting shaft 602 is angled away from the angled mounting shaft 502 by between 1 and 45 degrees. In yet a further implementation, the straight mounting shaft 602 is offset from the angled mounting shaft 502 by 34 degrees. In a further implementation, the straight mounting shaft 602 is angled away from the plane C such that a plane D defining the bottom portion of the straight mounting shaft 602 is parallel to plane B and/or plane A

With particular reference to FIG. 17, in one or more implementations, where the straight mounting shaft 602 and the angled mounting shaft 502 are joined, there are cutouts or depressions 402 disposed within the body of the hinge mount. In one implementation, the cutouts 504 are hemispherical. In another implementation, the cutouts 504 are rectangular.

In one or more implementations, as shown in FIG. 18, a bore hole 506 is provided through the body of the straight mounting shaft 602.

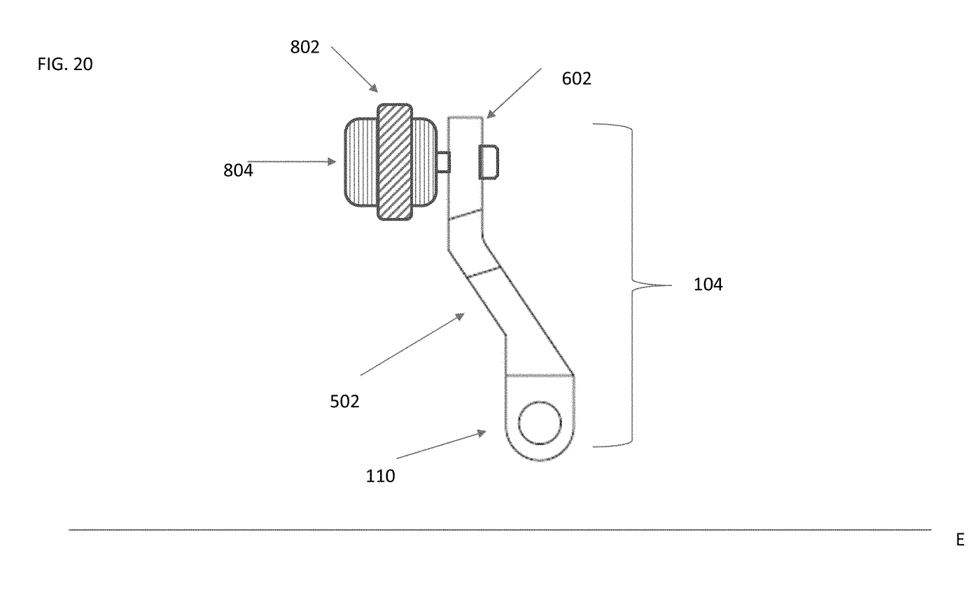

With reference to an illustrated implementation provided in FIG. 20, the work piece 802, such as a ring, is mounted to a mounting device 804, such as a cylinder. In one or more implementations, the work piece mounting device 804 is one or more expandable collets, aluminum cylinders, mounting boxes, mounting wheels or other device used to secure or approach a work piece 802. In a particular implementation, the mounting device 804 is an aluminum cylinder encased in shellac or another flexible material designed to retain the work piece on the mounting device. For example, mounting device 804 is used to secure the workpiece 802. Here, the mounting device 804 is a cylindrical or semi-cylindrical work piece mount. Depending on the size, diameter or shape of the workpiece 802, the mounting device 804 includes one or more striations or groves. The groves permit the application of shellac, rubber, or another compound that increases the diameter of the securing collar. Additionally, the application of shellac or another compound provides a change in surface texture. For example, shellac applied to the mounting device 804 allows a workpiece 802 to be mounted and retained to the mounting device 804 without the use of clamps, clips or mounting hardware that can damage or mar the work piece. In a further implementation, the mounting device 804 is configured with a mounting interface. The mounting interface is configured to interface with the bore hole of either the angled mounting shaft 502 or the straight mounting shaft 602. In one or more configurations, the mounting interface is a threaded bolt. In a further configuration, the mounting interface is a screw and nut combination. In yet a further implementation, the mounting interface is another commonly used securing device.

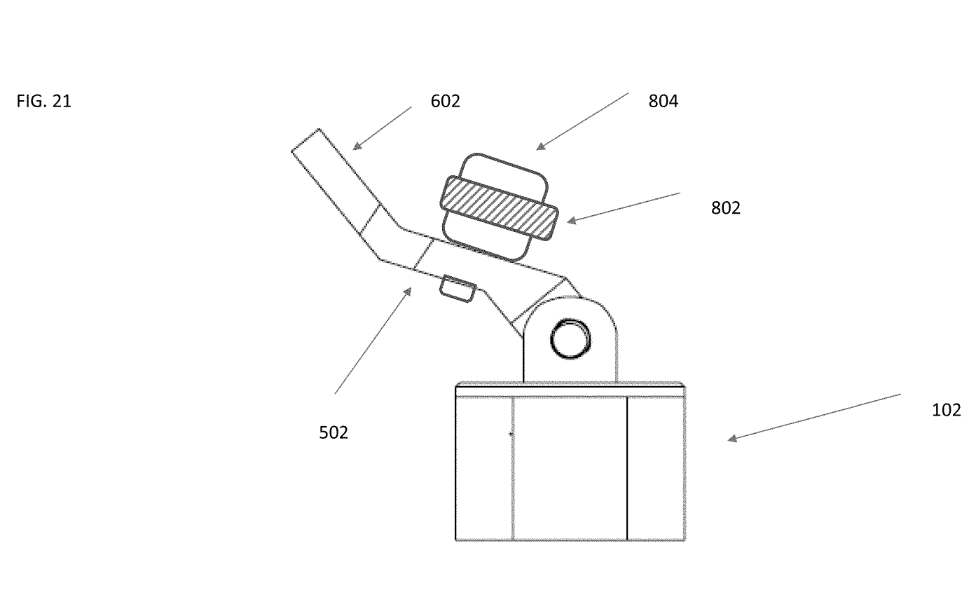

Without being held to any particular mode of operations, when the mounting device is interfaced with the straight mounting shaft a user can approach the work piece at a 90-degree angle. For instance, as shown in FIG. 20, the workpiece 802 is oriented at a 90-degree angle to the work surface defined by plane E. As shown in FIG. 21, when the hinge portion 104 is moved relative to the base portion 102 and the mounting device is coupled to the angled mounting shaft 504, the workpiece 802 is presented to the user at about a 45-degree angle relative to the base portion 102.

With a workpiece 802 secured, the craftsman can work with a steady speed in different places on the workpiece 802 while adjusting and positioning the workpiece 802 so that the craftsman is comfortable and can approach the workpiece 802 from different angles, so as to make different drill cuts and setting stone or engravings.

While this specification contains many specific embodiment details, these should not be construed as limitations on the scope of any embodiment or of what can be claimed, but rather as descriptions of features that can be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated together in a single software product or packaged into multiple software products.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain embodiments, multitasking and parallel processing can be advantageous.

Publications and references to known registered marks representing various systems are cited throughout this application, the disclosures of which are incorporated herein by reference. Citation of any above publications or documents is not intended as an admission that any of the foregoing is pertinent, nor does it constitute any admission as to the contents or date of these publications or documents. All references cited herein are incorporated by reference to the same extent as if each individual publication and references were specifically and individually indicated to be incorporated by reference.

While the invention has been particularly shown and described with reference to a preferred embodiment thereof, it will be understood by those skilled in the art that various changes in form and details may be made therein without departing from the spirit and scope of the invention. As such, the invention is not defined by the discussion that appears above, but rather is defined by the points that follow, the respective features recited in those points, and by equivalents of such features.

1. A workpiece retention tool, comprising:
(a) a clamp assembly;
(b) at least two gripping attachments selectively coupleable to the clamp assembly and configured to retain the workpiece, wherein the at least two of the gripping attachment are configured to exert a compressive force of the workpiece;
(c) the at least the two gripping attachments includes base and a retention head, the retention head having a top portion and a bottom portion defining an inclined gripping surface, wherein the top portion of the retention head extends beyond the bottom portion of the retention head.

2. The work piece of claim 1, where the clamp assembly includes a pair of actuated jaws and at least one of the gripping attachments is couplable to one of the actuated jaws.

3. The work piece of claim 1, where the degree of incline of the gripping surface from the top portion to the bottom portion is no more than 10 degrees.

4. The work piece of claim 3, where the degree of incline of the gripping surface from the top portion to the bottom portion is two (2) degrees.

5. The work piece of claim 1, wherein the top portion of the retention head surface has a first thickness and the bottom portion of the retention head has a second thickness, where in the first thickness is less than or equal to the second thickness.

6. The work piece of claim 1, wherein the top portion of the retention head surface and the bottom portion of the retention head define an inclined outer surface.

7. The work piece of claim 5, wherein the inclined outer surface has a degree of incline of no more than 45 degrees.

8. A workpiece retention tool, comprising:
(d) an expansion collar having a cylindrical shape adapted to secure substantially cylindrical workpiece, the expansion collar having a plurality of slots extending from a first end face, and a plurality of slots extending from a second face, wherein the plurality of slots extending at least half the width of the expansion collar;
(e) at least two expansion promoters configured to engage the first face and second face and cause the first and second faces to increase in diameter in response to a compressive force;
(f) a mounting element configured to mount the workpiece retention tool on or to a surface; and
(g) a selectively engagable compression device configured to apply compressive force to at least the two expansion promotors so as to apply compressive force to the first and second faces of the expansion collar.

9. The work piece of claim 8, where the plurality of slots are evenly circumferentially disposed about the circumference of the expansion collar.

10. The work piece of claim 8, wherein at least one of the plurality of slots terminates in a substantially circular opening.

11. The work piece of claim 10, wherein the substantially circular opening has a diameter larger than the width of the slot.

12. The work piece of claim 10, least one of the plurality of slots terminates at a point at least 75% of the length of the expansion collar from one of the faces of the expansion collar.

13. A workpiece retention apparatus, comprising:
(h) a base portion comprising
a. An elongated shaft member, a hinge member disposed at one end of the elongated shaft member, the hinge member having at least one through bore disposed therein, and
(i) A workpiece mount comprising
a. a connection portion configured to removably couple to the hinge member, an angled mounting shaft connected at one end to the connection portion, and a vertical mounting shaft connected to the other end of the angled mounting shaft.

14. The apparatus of claim 13, wherein the angled mounting shaft is angled away from the hinge member by between 1 and 90 degrees.

15. The apparatus of claim 14, wherein the angled mounting shaft is angled away from the hinge member by 34 degrees.

16. The apparatus of claim 13, wherein the vertical mounting shaft is angled away from the angled mounting shaft by between 1 and 90 degrees.

17. The apparatus of claim 16, wherein the vertical mounting shaft is angled away from the angled mounting shaft by member by 34 degrees.

18. The apparatus of claim 15, wherein the mounting shaft has at least one though bore disposed within the angled mounting shaft, and the vertical mounting shaft having at least one through bore disposed therethrough.

19. The apparatus of claim 13 further comprising a retention device selectively coupleable to either the vertical mounting shaft or the angled mounting shaft.

20. The apparatus of claim 13, wherein the retention device configured to mount a workpiece and wherein the base portion includes a plurality of risers configured to exert a compressive force on the connection portion, each of the risers having at least one beveled portion.
